(19) United States
(12) Patent Application Publication
(10) Pub. No.: US 2026/0309363 A1
(43) Pub. Date: Oct. 8, 2026

(54) Modular Leg Supports for Heat Pump Outdoor Units

(71) Applicant: Leonard DeAngelo, Marblehead, MA (US)

(72) Inventor: Leonard DeAngelo, Marblehead, MA (US)

(21) Appl. No.: 19/568,876

(22) Filed: Mar. 17, 2026

Related U.S. Application Data
(60) Provisional application No. 63/782,483, filed on Apr. 2, 2025.

(51) Int. Cl. F24F 13/32; F16M 7/00; F24F 1/40

(52) U.S. Cl. CPC F24F 13/32; F16M 7/00; F24F 1/40

(57) ABSTRACT

The present invention provides a modular leg support system for supporting a residential air conditioning heat pump outdoor unit. The system includes a set of four individual legs and or double-leg assemblies, which may be used independently or together to elevate and stabilize the heat pump outdoor unit above ground level. Each individual leg features a shaft, a footpad for ground stability, and a mounting plate with pre-drilled openings for attachment. The double-leg assemblies include paired vertical supports, a crossbar, footpads, and a slotted mounting bracket with a platform for adjustable installation. The components are constructed from corrosion-resistant materials and are compatible with various heat pump outdoor mounting configurations. This system improves airflow, reduces vibration and noise, protects against environmental hazards, and allows installation on uneven terrain, providing a durable, adaptable, and efficient support solution for residential HVAC applications.

### CROSS-REFERENCE TO RELATED APPLICATION

This application claims the benefit of and priority to U.S. Provisional Patent Application No. 63/782,483, filed Apr. 2, 2025, the contents of all of which are incorporated herein by reference.

### FIELD OF THE INVENTION

This invention relates to a system of modular leg supports for heat pump outdoor units.

### BACKGROUND OF INVENTION

Air conditioning systems are essential components of residential buildings, particularly in regions with extreme summer temperatures. These systems rely on outdoor heat pump outdoor units, which play a critical role in cooling the refrigerant used in the system. Traditionally, heat pump outdoor units are placed on the ground, either on a concrete pad or another flat surface. However, this method presents multiple challenges related to space efficiency, protection, and performance.

One of the most common issues with ground-mounted heat pump outdoor units is exposure to environmental hazards. Debris, water accumulation, and snow can obstruct airflow or cause damage to the heat pump outdoor coils, reducing efficiency and increasing maintenance requirements. Ground-level installations are susceptible to water accumulation, corrosion from pooled moisture, vegetation overgrowth, pest infestation, and blockage of airflow due to debris buildup. Additionally, ground placement makes the unit more susceptible to damage from lawn equipment, animals, and accidental impacts.

Another significant drawback of placing heat pump outdoor units at ground level is the potential for vibration transmission into the home. When mounted improperly, vibrations from the compressor can travel through the structure, creating noise disturbances that affect indoor comfort. Additionally, when heat pump outdoor units rest on unstable or uneven ground, they are prone to vibration, which can increase wear on internal components and transmit noise into the building. These vibrations may also loosen fasteners over time, compromising the integrity of the installation.

Efforts have been made to design elevated mounting solutions, such as rooftop installations or freestanding platforms. However, rooftop mounting is not always feasible due to structural limitations, and freestanding platforms often require additional support structures, increasing material costs and installation complexity.

There remains a need for a modular, durable, and easy-to-install support system for air conditioning heat pump outdoor units that accommodates various terrain types and unit dimensions. Such a system should elevate the unit, minimize vibration, improve drainage and airflow, and simplify installation.

The present invention addresses these challenges by introducing a combination of a single four-legged support units and paired double-leg configurations. These leg systems offer a customizable and scalable support structure, reducing ground contact, increasing unit longevity, and improving overall performance.

This invention not only simplifies the installation process but also provides a cost-effective, vibration-reducing, and environmentally adaptable platform for heat pump outdoor units, thereby enhancing the reliability and lifespan of residential air conditioning systems.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The present invention relates to a modular leg support system for a residential air conditioning heat pump outdoor unit. The system includes a set of four individual legs and one or more double-leg assemblies, which may be used separately or together to elevate and stabilize the heat pump outdoor unit above ground level.

Each individual leg includes a vertical shaft, a footpad, and a mounting plate with pre-drilled openings for compatibility with a range of mounting configurations. The double-leg assemblies feature paired vertical supports, a horizontal crossbar, footpads, and a mounting bracket with a slotted platform for adjustable mounting.

All components are made from corrosion-resistant materials and are designed to enhance airflow, reduce vibration and noise, and protect the heat pump outdoor unit from environmental hazards. The system is adaptable to various terrain types and unit sizes, offering a durable, easy-to-install, and efficient solution for HVAC applications.

In one embodiment, the invention provides a modular leg support system comprising four individual legs for supporting a residential air conditioning heat pump outdoor unit. Each individual leg includes a vertical shaft that provides structural height and load-bearing capacity, a broad footpad at the lower end for ground contact and stability, and a mounting plate at the upper end configured to attach to the base of the heat pump outdoor unit. The mounting plate includes a plurality of pre-drilled openings, which may be round or slotted, to accommodate various fasteners and heat pump outdoor unit mounting configurations. In certain embodiments, the mounting plate includes anti-vibration bushings, and a vibration dampener is positioned between the shaft and plate to reduce operational noise. Some versions may also include an angled stabilizing brace between the shaft and plate for enhanced rigidity. The footpads may be fixed or height-adjustable to allow leveling on uneven terrain, and all components may be constructed from corrosion-resistant materials such as galvanized steel, powder-coated aluminum, stainless steel, or composite polymers.

In another embodiment, the system comprises one or more double-leg assemblies for supporting larger or elongated heat pump outdoor units. Each double-leg assembly includes two vertical supports joined near their bases by a horizontal crossbar, and each support is equipped with a ground-engaging footpad. A mounting bracket spans the top of the vertical supports and includes a slotted platform that allows adjustable positioning of the heat pump outdoor unit. In some embodiments, the crossbar is telescopic to permit flexible spacing between the legs. The footpads may pivot or adjust in height to conform to uneven surfaces, and the mounting bracket may incorporate vibration dampening features. The slotted platform may contain elongated or grid-patterned openings to accommodate a variety of heat pump outdoor base configurations. As with the individual leg embodiment, fasteners such as bolts, washers, lock nuts, and anti-vibration bushings may be used to secure the mounting system to the heat pump outdoor. Double-leg assemblies may also be combined with individual legs in hybrid configurations, offering further adaptability to installation needs.

These embodiments collectively provide a flexible, stable, and vibration-reducing support structure that elevates the heat pump outdoor unit above ground-level hazards, enhances airflow, and simplifies installation across a range of terrains and unit sizes.

The present invention also discloses a modular support system for elevating a residential heat pump outdoor unit above ground level with heat pump risers configured to elevate heat pump outdoor units slightly above a supporting surface. In many installations, heat pumps are secured to such risers using adhesives, particularly where mechanical fastening is not preferred or where the unit is simply pressed onto the riser during installation. The disclosed riser system may also be used to support other types of outdoor condensers, allowing the same riser structure to elevate and stabilize different HVAC outdoor units.

The system includes individual riser supports and optional paired support assemblies that may be used independently or in combination. Each riser includes a vertical support portion, a ground-engaging base, and an upper support interface configured to engage the base of a heat pump condenser or other outdoor unit. The risers provide improved airflow beneath the unit, reduce exposure to ground-level moisture, debris, and pests, and assist in vibration reduction.

The modular design allows the risers to accommodate different unit footprints, installation conditions, and load requirements, while remaining compatible with both adhesive-secured installations and mechanically fastened installations.

In another embodiment, the present invention provides a modular support system comprising a plurality of heat pump risers positioned beneath a base of the heat pump outdoor unit. Each heat pump riser includes a ground-engaging base portion and an upper support interface configured to support the base of the heat pump outdoor unit while providing vertical separation between the heat pump outdoor unit and the supporting surface. The risers may be arranged proximate to corners or load-bearing portions of the heat pump outdoor unit to elevate the unit above ground level and improve airflow beneath the unit.

In a further embodiment, the invention provides a hybrid support system including a combination of individual legs and heat pump risers configured to support a heat pump outdoor unit. In this configuration, one or more individual legs provide structural load-bearing support while one or more heat pump risers provide supplemental elevation and stabilization. The hybrid configuration allows installers to adapt the support system to irregular equipment footprints, uneven terrain conditions, or non-uniform load distributions.

In another embodiment, the support system includes a plurality of adjustable support members configured to allow selective vertical adjustment of the heat pump outdoor unit relative to a supporting surface. Each adjustable support member may include a telescoping shaft, threaded adjustment mechanism, spacer system, or other height-adjustment structure that enables installers to level the heat pump outdoor unit on uneven terrain or sloped mounting surfaces.

In a further embodiment, the invention provides a support system in which the heat pump outdoor unit is secured to the mounting plates, mounting brackets, or heat pump risers using an adhesive bonding interface. In such embodiments, the upper support surfaces of the legs, brackets, or risers may include textured surfaces, bonding pads, elastomeric layers, or adhesive-receiving surfaces configured to facilitate adhesive attachment between the support system and the base of the heat pump outdoor unit.

In another embodiment, the support system includes integrated vibration isolation components positioned between the support system and the heat pump outdoor unit. The vibration isolation components may include elastomeric pads, rubber isolators, polymer dampeners, spring elements, or composite vibration-reduction materials configured to reduce transmission of operational vibration from the heat pump outdoor unit to the supporting surface.

In another embodiment, the invention provides a modular support system that includes anchoring features configured to secure the support system to a supporting surface. Such anchoring features may include anchor openings, anchor brackets, embedded mounting plates, threaded receivers, or ground-engaging spikes configured to secure the legs, assemblies, or risers to concrete pads, ground surfaces, rooftop platforms, or structural mounting frames.

In a further embodiment, the modular support system is configured to support outdoor HVAC equipment other than heat pump outdoor units. The support system may be used to elevate air conditioning condenser units, mini-split outdoor units, variable refrigerant flow (VRF) outdoor units, refrigeration condenser assemblies, compressor units, or other outdoor mechanical equipment requiring elevation above a supporting surface.

In a further embodiment, the modular support system includes structural reinforcement elements integrated into the legs, crossbars, assemblies, or risers to increase load-bearing capacity. Such reinforcement elements may include gussets, ribs, reinforcement plates, structural flanges, lattice structures, or composite reinforcement materials configured to enhance rigidity and durability of the support system.

In another embodiment, the modular support system includes components formed as integrated structures in which two or more structural elements are manufactured as a single unit. For example, the vertical shaft, footpad, and mounting plate of an individual leg may be formed as a single integrated structure, or the crossbars and mounting brackets may be integrated directly into double-leg assemblies to simplify installation and improve structural stability.

In a further embodiment, the support system may be configured to interface with existing mounting structures such as concrete pads, rooftop brackets, equipment rails, or mechanical equipment platforms. In such embodiments, the legs, assemblies, or risers may function as intermediate elevation supports positioned between the equipment base and the underlying mounting structure.

In a further embodiment, the present invention provides a modular support system in which the individual legs, double-leg assemblies, or heat pump risers include integrated airflow clearance features configured to maintain a predetermined airflow gap beneath the heat pump outdoor unit. The airflow clearance features may include elevated support surfaces, recessed mounting interfaces, structural openings, or airflow channels formed within the support components to improve heat exchange efficiency by promoting unobstructed airflow beneath the heat pump outdoor unit.

In another embodiment, the invention provides a modular support system in which the legs, assemblies, or risers include surface stabilization features configured to improve engagement with a supporting surface. Such stabilization features may include textured base surfaces, serrated or patterned footpads, elastomeric ground-contact materials, anti-slip coatings, or multi-surface contact structures designed to enhance stability when installed on soil, gravel, concrete, decking, roofing membranes, or other installation environments.

In another embodiment, the modular support system includes lateral stabilization structures configured to reduce movement of the heat pump outdoor unit caused by vibration, wind loads, or operational forces. Such lateral stabilization structures may include cross members, reinforcement brackets, diagonal supports, lateral braces, or interconnecting structural elements positioned between two or more legs, assemblies, or risers to increase structural rigidity of the support system.

In a further embodiment, the invention provides a modular support system configured to distribute the load of the heat pump outdoor unit across multiple ground-engaging contact points. In such embodiments, the footpads of the legs, assemblies, or risers may include enlarged load distribution surfaces, multi-surface base plates, or extended support bases designed to reduce ground pressure and improve stability when installed on soft or uneven ground surfaces.

In another embodiment, the support system includes modular interface structures configured to allow the support components to be selectively combined, repositioned, or expanded to accommodate different equipment sizes. These modular interface structures may include slotted mounting interfaces, telescoping crossbars, adjustable connection points, or interchangeable mounting plates that allow installers to configure the support system to match the base dimensions and load distribution characteristics of different heat pump outdoor units or other outdoor HVAC equipment.

In another embodiment, the present invention provides a modular support system including support members having multi-surface equipment engagement interfaces configured to accommodate different base geometries of heat pump outdoor units. In this configuration, the upper support interfaces of the legs, assemblies, or risers may include multiple mounting regions, stepped surfaces, or distributed contact zones configured to support equipment bases having different footprints, base frame structures, or mounting patterns. These multi-surface engagement interfaces allow the support system to securely support a variety of outdoor HVAC unit configurations without requiring custom support structures.

In a further embodiment, the invention provides a modular support system including integrated structural alignment features configured to assist in positioning the heat pump outdoor unit during installation. Such alignment features may include positioning ridges, guide rails, recessed mounting regions, alignment channels, or perimeter engagement surfaces configured to guide the base of the heat pump outdoor unit into a stable position relative to the support system. These alignment features may reduce installation time and improve stability of the supported unit.

In another embodiment, the modular support system includes environmental clearance structures configured to elevate the heat pump outdoor unit to a predetermined height above the supporting surface. These clearance structures may include extended support legs, elevated riser structures, adjustable-height supports, or stacked support modules that provide sufficient vertical clearance to reduce accumulation of snow, standing water, vegetation, debris, or other environmental obstructions beneath the heat pump outdoor unit.

In a further embodiment, the present invention provides a modular support system for elevating an outdoor HVAC unit above a supporting surface, the system comprising a plurality of support members positioned beneath the base of the outdoor HVAC unit. Each support member includes a ground-engaging base and an upper support interface configured to support the outdoor HVAC unit while providing vertical separation between the unit and the supporting surface to improve airflow and reduce exposure to environmental hazards.

In another embodiment, the invention provides a modular support system comprising a plurality of adjustable support members configured to elevate and level a heat pump outdoor unit relative to a supporting surface. Each support member includes a height-adjustment mechanism that allows installers to selectively raise or lower portions of the heat pump outdoor unit to compensate for uneven terrain or sloped installation surfaces.

In a further embodiment, the invention provides a modular support system including a plurality of interconnected support structures arranged beneath a heat pump outdoor unit. The support structures are connected by one or more cross members configured to distribute loads between multiple support points and provide lateral stability to the supported unit.

In another embodiment, the invention provides a support system including a plurality of heat pump risers positioned beneath a base of the heat pump outdoor unit, each riser including a ground-engaging base portion and an upper equipment support interface configured to support the heat pump outdoor unit while maintaining an airflow gap between the supporting surface and the heat pump outdoor unit.

In a further embodiment, the invention provides a hybrid support system comprising a combination of structural legs and heat pump risers positioned beneath a heat pump outdoor unit. In such configurations, structural legs may provide primary load-bearing support while heat pump risers provide additional elevation and stabilization at selected support locations beneath the unit.

In another embodiment, the invention provides a support system including vibration isolation structures positioned between the support system and the heat pump outdoor unit. The vibration isolation structures are configured to reduce transmission of operational vibration from the heat pump outdoor unit to the supporting surface while maintaining structural stability of the elevated unit.

In another embodiment, the invention provides a modular support system including anchoring features configured to secure the support system to a supporting surface. The anchoring features may include anchor openings, anchor brackets, threaded anchor receivers, or ground-engaging anchors configured to secure the support system to concrete surfaces, ground surfaces, rooftop platforms, or structural mounting frames.

In a further embodiment, the invention provides a modular support system configured to support a variety of outdoor HVAC equipment including heat pump outdoor units, air conditioning condenser units, refrigeration condensers, mini-split outdoor units, and variable refrigerant flow outdoor systems, the support system being configured to elevate such equipment above a supporting surface while maintaining structural stability and airflow clearance beneath the equipment.

In a further embodiment, the present invention provides a modular support kit for elevating a heat pump outdoor unit above a supporting surface. The support kit includes a plurality of individual legs configured to be installed beneath the base of a heat pump outdoor unit. Each leg includes a vertical shaft, a ground-engaging footpad, and an upper mounting plate configured to engage the base of the heat pump outdoor unit. The legs are provided as a packaged set configured for installation by an installer to elevate and stabilize the heat pump outdoor unit.

In another embodiment, the invention provides a modular installation kit comprising a plurality of support components including individual legs, crossbars, and mounting hardware configured to assemble into a support structure for elevating a heat pump outdoor unit. The kit may include fasteners, washers, vibration isolation components, and adjustable mounting interfaces configured to allow an installer to assemble the support structure beneath the heat pump outdoor unit.

In a further embodiment, the invention provides a modular support kit including one or more double-leg assemblies and associated mounting hardware configured to support larger or elongated heat pump outdoor units. The kit may include paired vertical supports, crossbars, mounting brackets, and adjustable slotted platforms configured to allow installers to adapt the support structure to different equipment footprints.

In another embodiment, the invention provides a modular riser kit including a plurality of heat pump risers configured to be positioned beneath the base of a heat pump outdoor unit to elevate the unit above a supporting surface. Each riser includes a ground-engaging base and an upper equipment support interface configured to support the heat pump outdoor unit while providing an airflow clearance gap beneath the unit.

In a further embodiment, the invention provides a configurable modular support kit including a combination of legs, double-leg assemblies, and heat pump risers configured to be selectively assembled beneath a heat pump outdoor unit depending on installation requirements. The kit may allow installers to configure different support arrangements based on equipment dimensions, terrain conditions, and load distribution requirements.

In a further embodiment, the present invention provides a method of elevating a heat pump outdoor unit above a supporting surface using a modular support system. The method includes positioning a plurality of individual legs beneath the base of the heat pump outdoor unit, aligning mounting plates of the legs with corresponding mounting locations on the heat pump outdoor unit, and securing the heat pump outdoor unit to the legs using mechanical fasteners such that the heat pump outdoor unit is elevated above the supporting surface to improve airflow and reduce exposure to environmental hazards.

In another embodiment, the invention provides a method of installing a modular support system beneath a heat pump outdoor unit, the method including positioning a plurality of support members on a supporting surface, adjusting one or more support members to compensate for uneven terrain, and placing the heat pump outdoor unit onto upper support interfaces of the support members such that the heat pump outdoor unit is supported in a level orientation above the supporting surface.

In a further embodiment, the invention provides a method of installing a support system including one or more double-leg assemblies beneath a heat pump outdoor unit. The method includes positioning the double-leg assemblies beneath opposing sides of the heat pump outdoor unit, adjusting spacing between vertical supports using telescopic crossbars or slotted mounting interfaces, and securing the heat pump outdoor unit to mounting brackets of the assemblies to stabilize the unit above the supporting surface.

In a further embodiment, the invention provides a method of installing heat pump risers beneath a heat pump outdoor unit. The method includes positioning a plurality of heat pump risers beneath the base of the heat pump outdoor unit, placing the heat pump outdoor unit onto upper support interfaces of the risers, and securing the heat pump outdoor unit to the risers using adhesive bonding, mechanical fasteners, or friction engagement such that the heat pump outdoor unit is elevated above the supporting surface.

In another embodiment, the invention provides a method of configuring a modular support system for a heat pump outdoor unit by selecting a combination of legs, double-leg assemblies, and heat pump risers from a modular support kit and arranging the selected support components beneath the base of the heat pump outdoor unit according to the footprint and load distribution of the unit, thereby elevating and stabilizing the heat pump outdoor unit above the supporting surface.

### DESCRIPTION OF THE FIGURES OF THE DRAWINGS

Advantages of the present invention will be apparent from the following detailed description of embodiments, which description should be considered in conjunction with the accompanying drawings, in which:

FIG. 1 Illustrates a top perspective view of a first embodiment of a set of individual legs for a heat pump outdoor unit of an air conditioning system.

FIG. 2 Illustrates a front view of the set of individual legs for a heat pump outdoor unit.

FIG. 3 Illustrates a left side view of the set of individual legs for a heat pump outdoor unit.

FIG. 4 Illustrates a right side view of the set of individual legs for a heat pump outdoor unit.

FIG. 5 Illustrates a top view of the set of individual legs for a heat pump outdoor unit.

FIG. 6 Illustrates another top view of the set of individual legs for a heat pump outdoor unit.

FIG. 7 Illustrates a top perspective view of a second embodiment of a set of individual legs for a heat pump outdoor unit of an air conditioning system.

FIG. 8 Illustrates a front view of the second embodiment.

FIG. 9 Illustrates a left side view of the second embodiment.

FIG. 10 Illustrates a right side view of the second embodiment.

FIG. 11 Illustrates a top view of an individual leg for a heat pump outdoor unit.

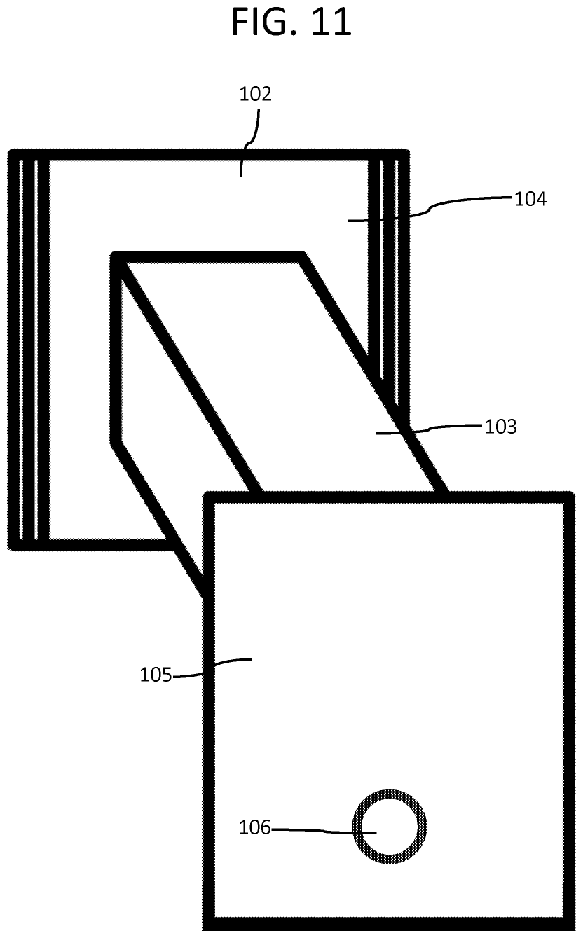

FIG. 12 Illustrates another top view of an individual leg for a heat pump outdoor unit.

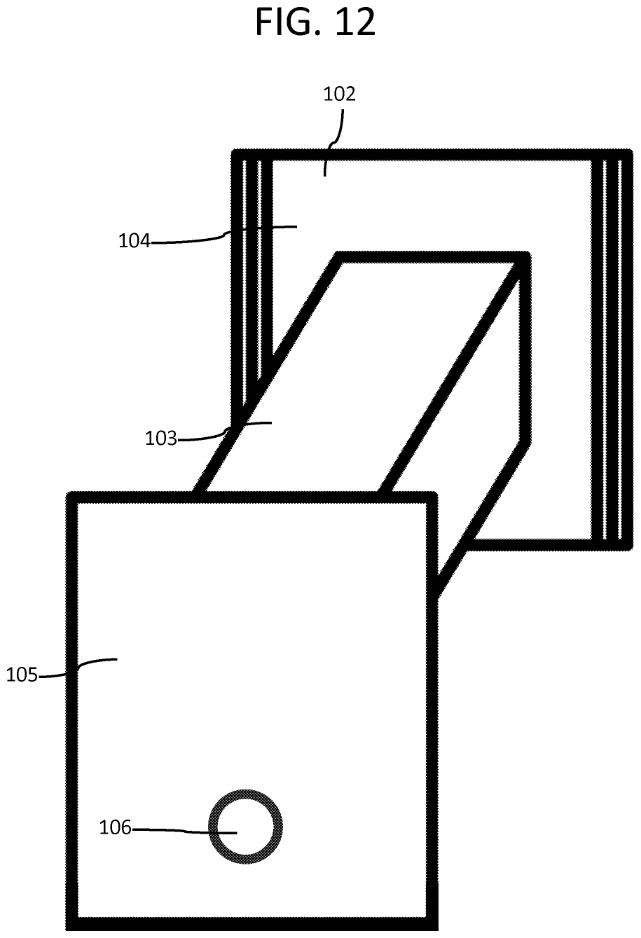

FIG. 13 Illustrates a front view of an individual leg for a heat pump outdoor unit.

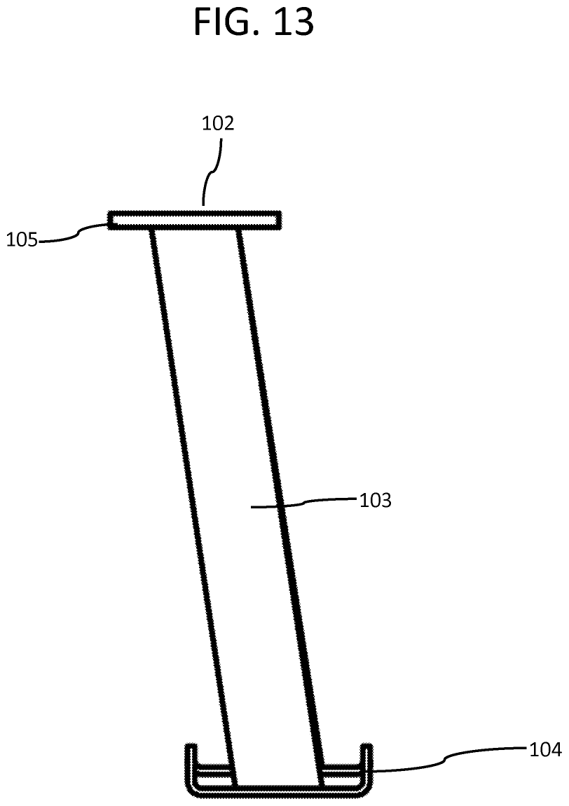

FIG. 14 Illustrates a rear view of an individual leg for a heat pump outdoor unit.

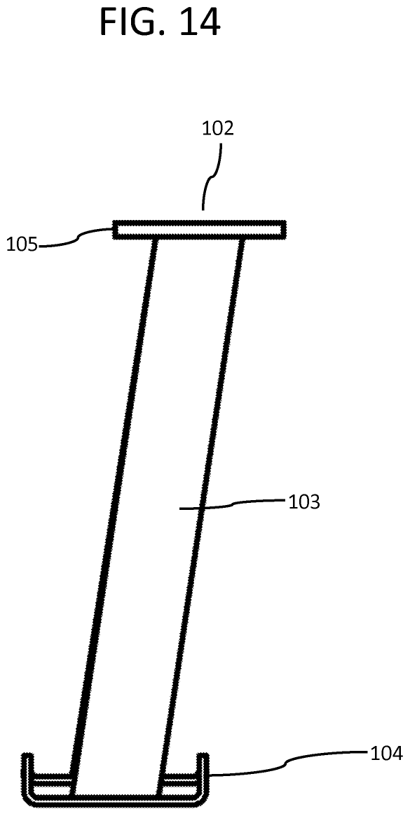

FIG. 15 Illustrates a side view of an individual leg for a heat pump outdoor unit.

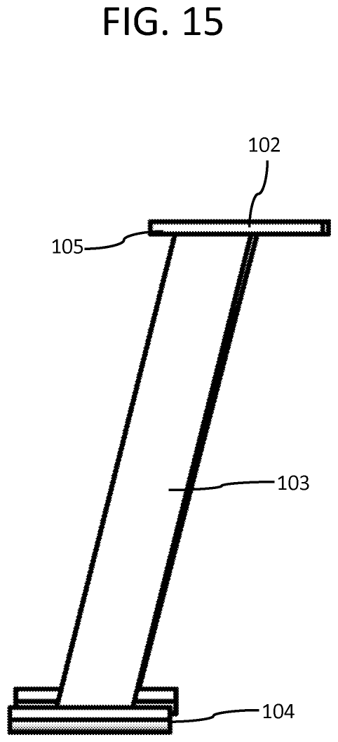

FIG. 16 Illustrates another side view of an individual leg for a heat pump outdoor unit.

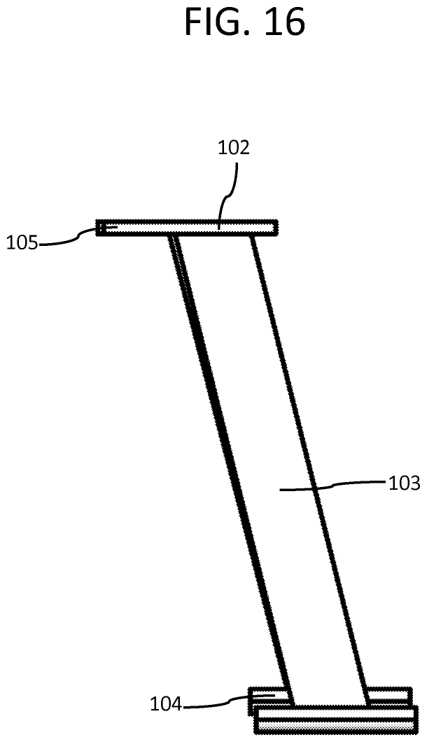

FIG. 17 Illustrates a top perspective view of an individual leg for the heat pump outdoor unit;

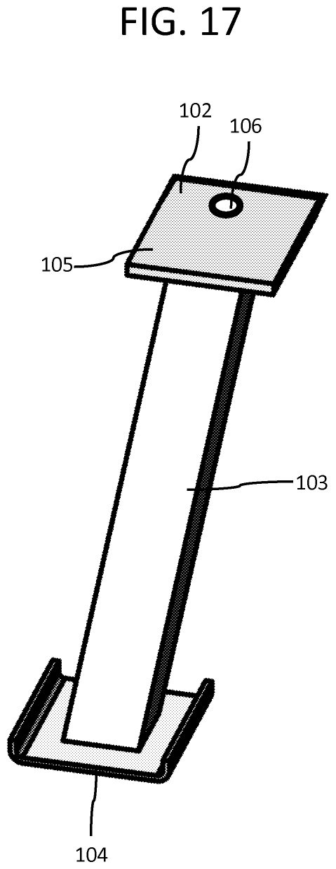

FIG. 18 Illustrates another top perspective view of the individual leg for the heat pump outdoor unit.

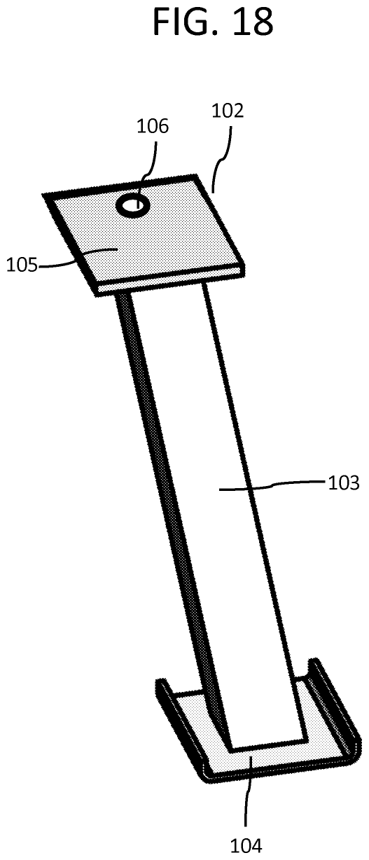

FIG. 19 Illustrates a top view of a footpad for an individual leg.

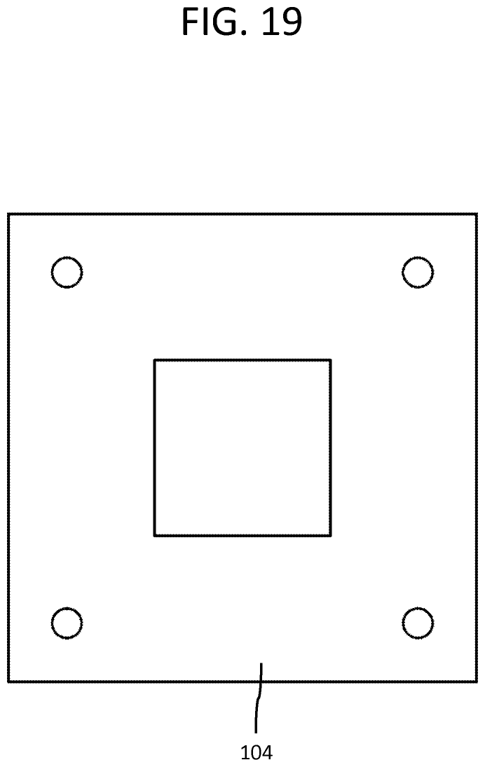

FIG. 20 Illustrates a top view of a mounting plate for individual leg.

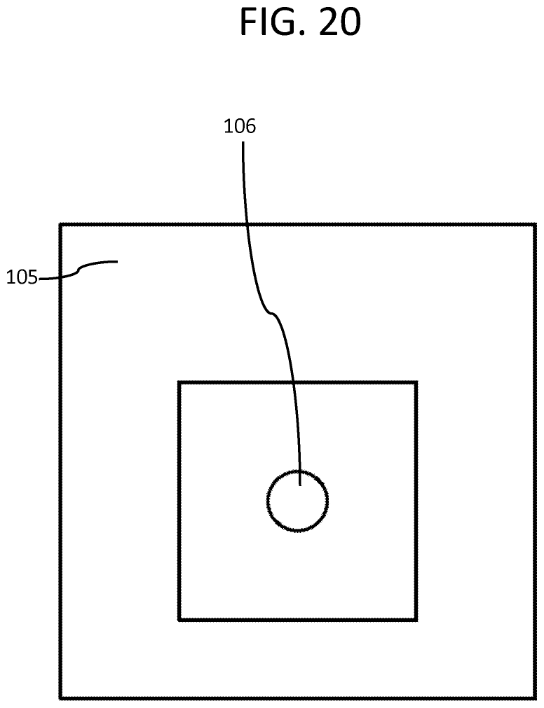

FIG. 21 Illustrates a top view of a first individual cross bar for a heat pump outdoor unit.

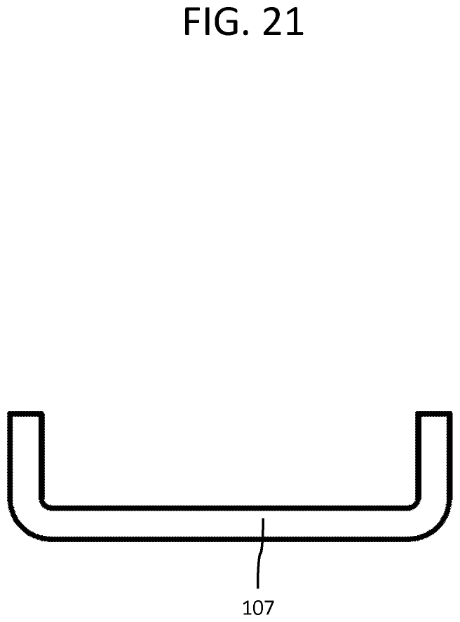

FIG. 22 Illustrates a top view of a second individual cross bar for a heat pump outdoor unit.

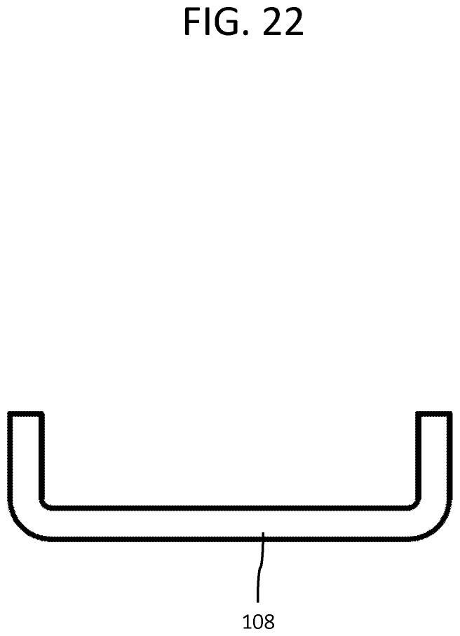

FIG. 23 Illustrates a bottom perspective view of a set of double legs for a heat pump outdoor unit of an air conditioning system.

FIG. 24 Illustrates a side view of the set of double legs for a heat pump outdoor unit of an air conditioning system.

FIG. 25 Illustrates a top view of the set of double legs for a heat pump outdoor unit of an air conditioning system.

FIG. 26 Illustrates a front view of the set of double legs for a heat pump outdoor unit of an air conditioning system.

FIG. 27 Illustrates a top perspective view of an individual double leg for a heat pump outdoor unit of an air conditioning system.

FIG. 28 Illustrates a top view of a heat pump riser.

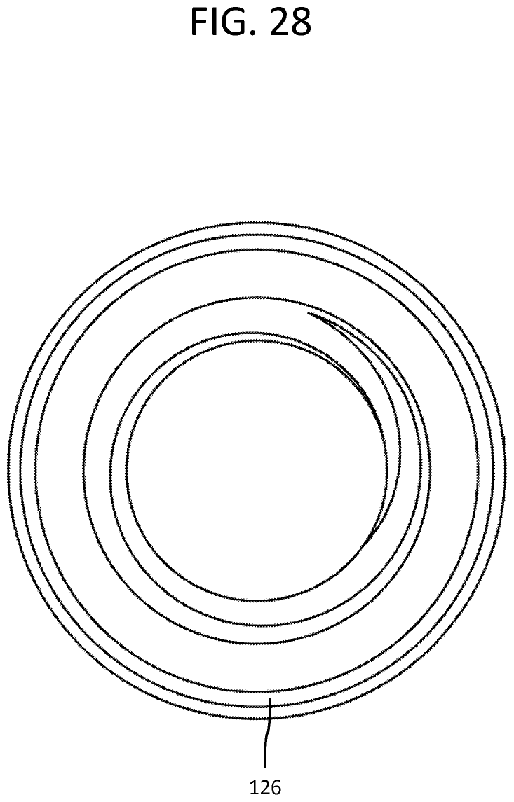

FIG. 29 Illustrates a top perspective view of a heat pump riser.

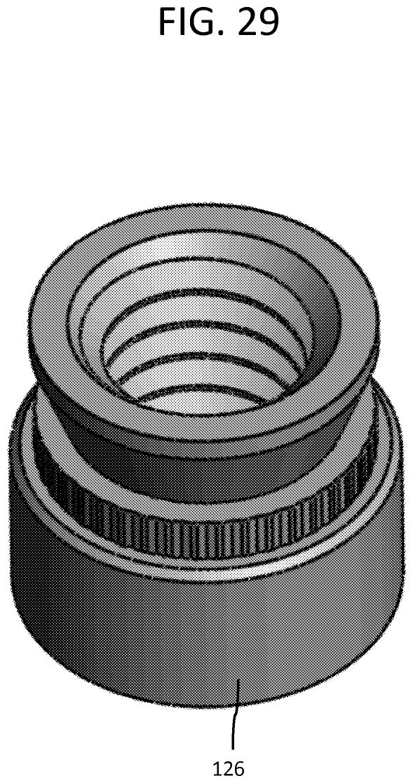

FIG. 30 Illustrates a side view of a heat pump riser.

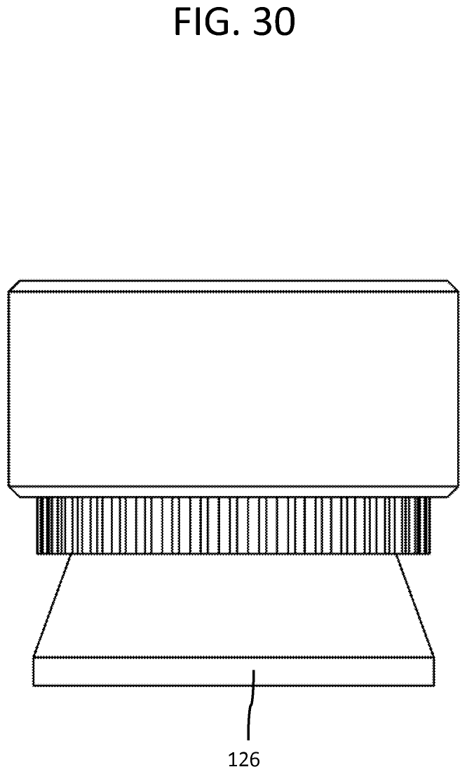

### DETAILED DESCRIPTION OF THE INVENTION

The present invention provides a modular leg support system for supporting a heat pump outdoor unit (101) of a residential air conditioning system. The system comprises a set of four individual legs (102) and one or more double-leg assemblies (120). These components may be used independently or in combination to elevate and stabilize the heat pump outdoor unit (101) above ground level, improving performance, longevity, and ease of maintenance

The legs (102 and 120) described in this invention may also be referred to using alternative terminology commonly used in the HVAC and construction industries. These include, but are not limited to support posts, mounting legs, stabilizer legs, heat pump outdoor stands, foot supports, base legs, bracket legs, riser legs, elevation supports, structural posts, unit feet, and anchoring legs. Each of these terms may be used interchangeably depending on the specific application, configuration, or industry context, and all are intended to encompass the same structural and functional components disclosed herein.

The heat pump outdoor unit (101) described in this invention may also be referred to by a variety of alternative names commonly used in residential HVAC contexts. These include, but are not limited to outdoor unit, external unit, condensing unit, AC compressor unit, refrigeration unit, HVAC outdoor assembly, heat exchange unit, cooling module, compressor assembly, and air conditioning box. These terms may vary based on regional usage, manufacturer terminology, or specific system configurations, but all refer to the external component of an air conditioning system responsible for releasing heat from the refrigerant and enabling effective indoor cooling.

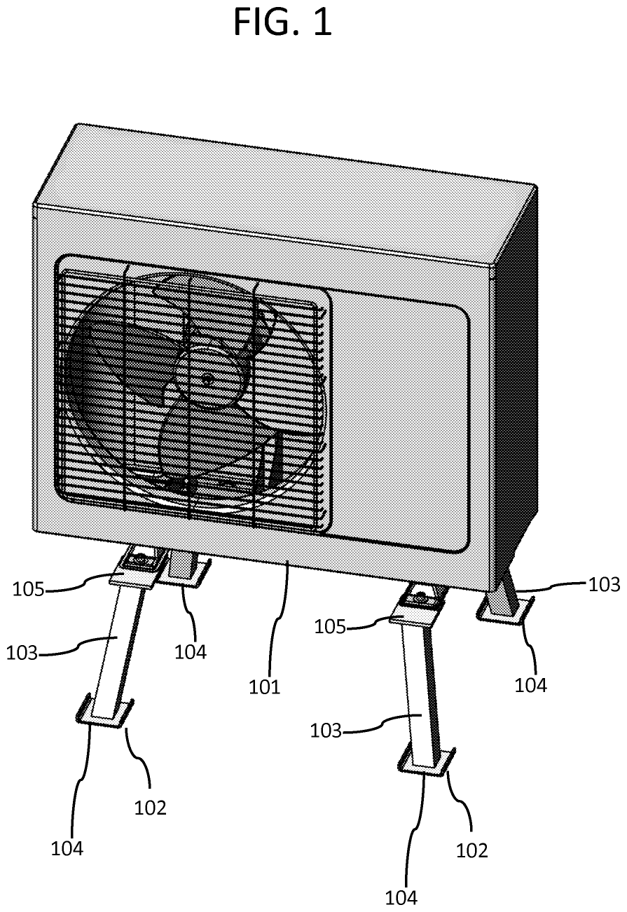

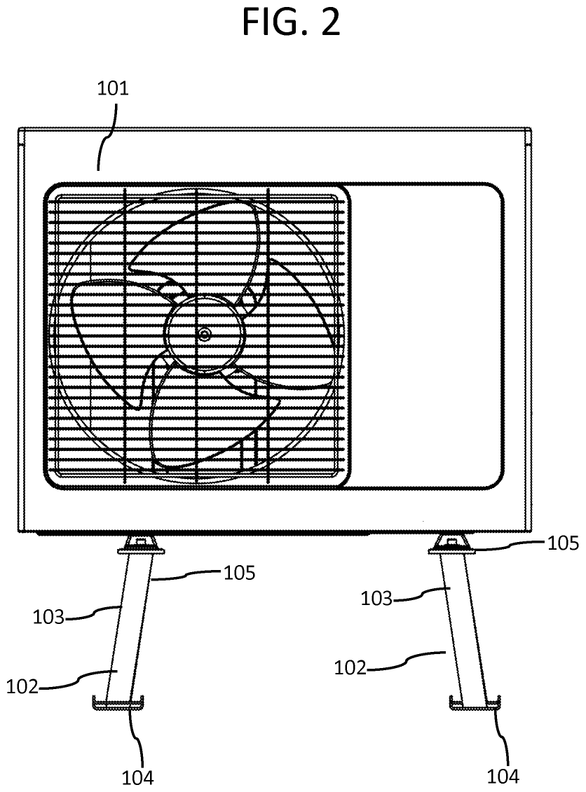

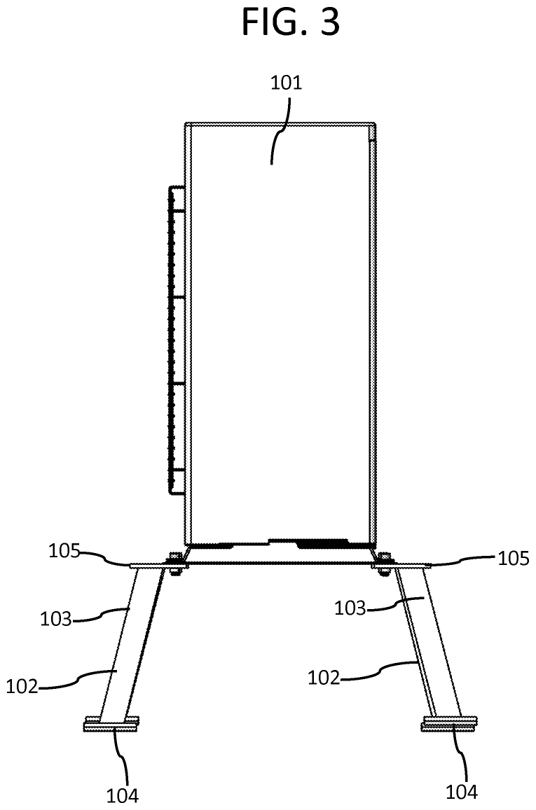

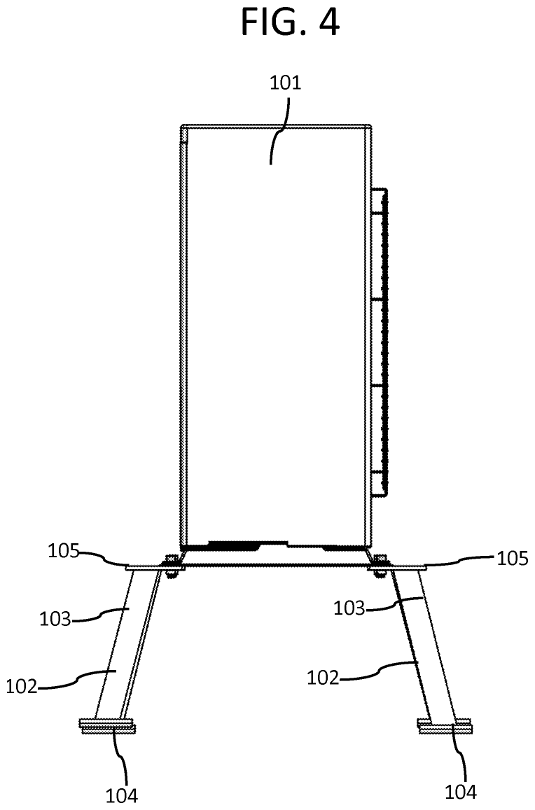

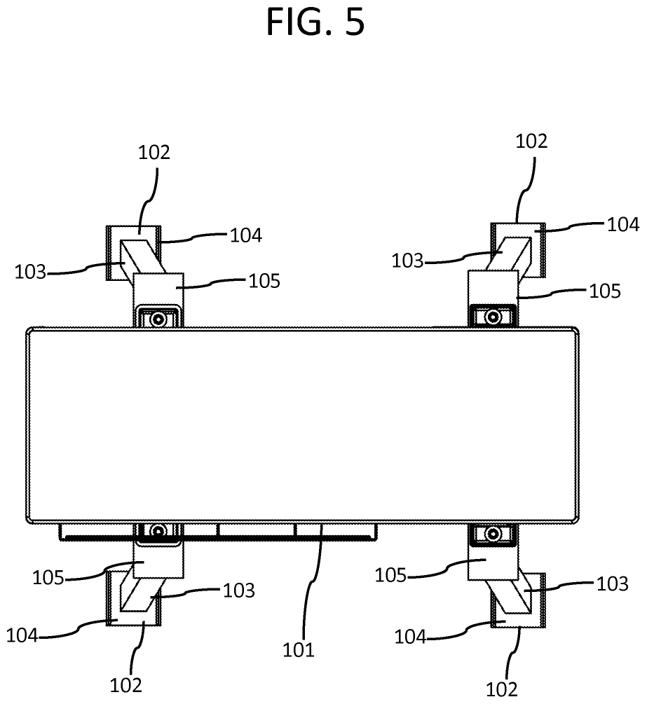

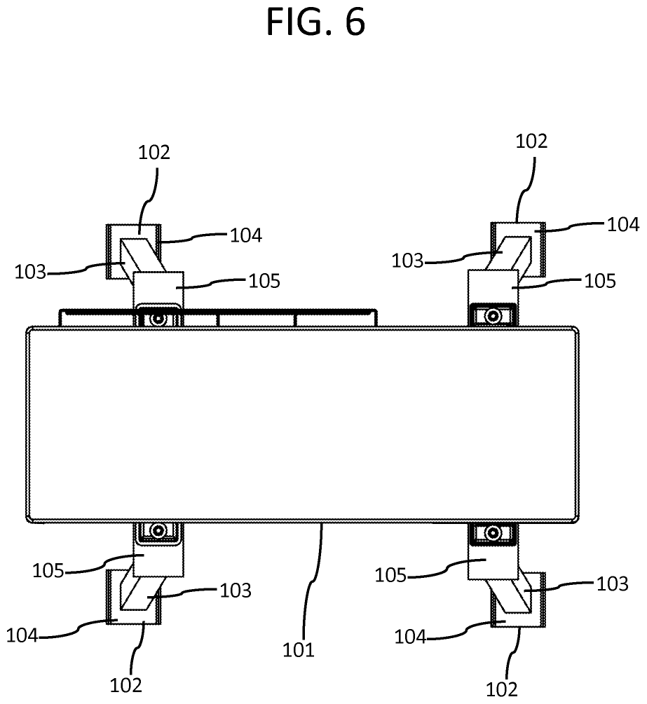

As shown in FIGS. 1 through 6, the individual legs (102) are designed to be mounted proximate to each corner of the heat pump outdoor unit (101). Each leg (102) includes a vertical shaft (103) that provides structural height and load-bearing capacity. At the base of the vertical shaft (103) is a footpad (104) with a broad, flat surface for improved load distribution and stability on uneven terrain. The top of each leg (102) includes a mounting plate (105), which interfaces directly with the bottom of the heat pump outdoor unit (101). The mounting plate (105) includes pre-drilled openings (106) configured to receive fasteners, allowing compatibility with a range of heat pump outdoor brands and mounting hole configurations.

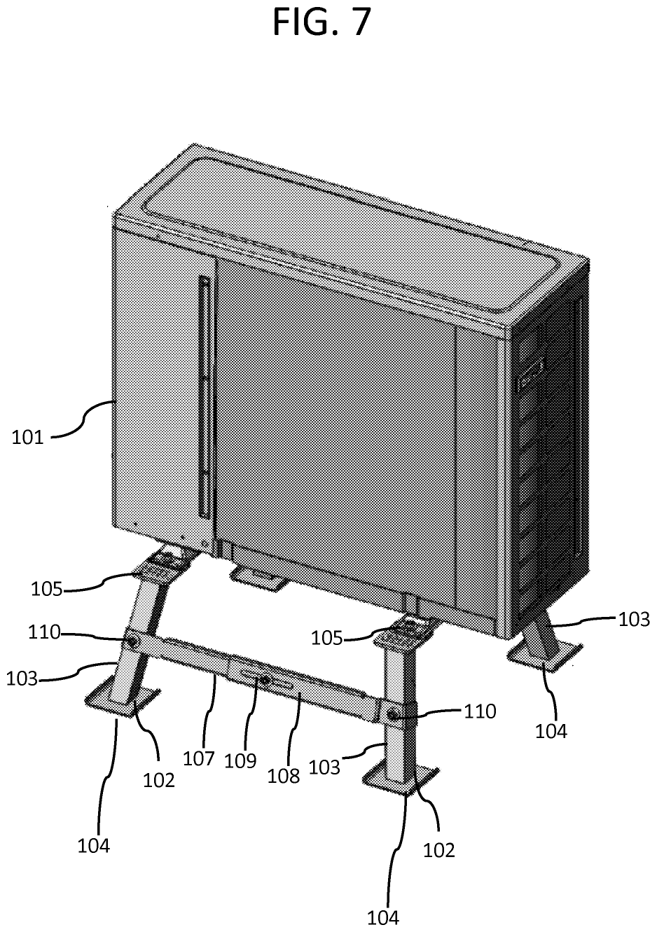

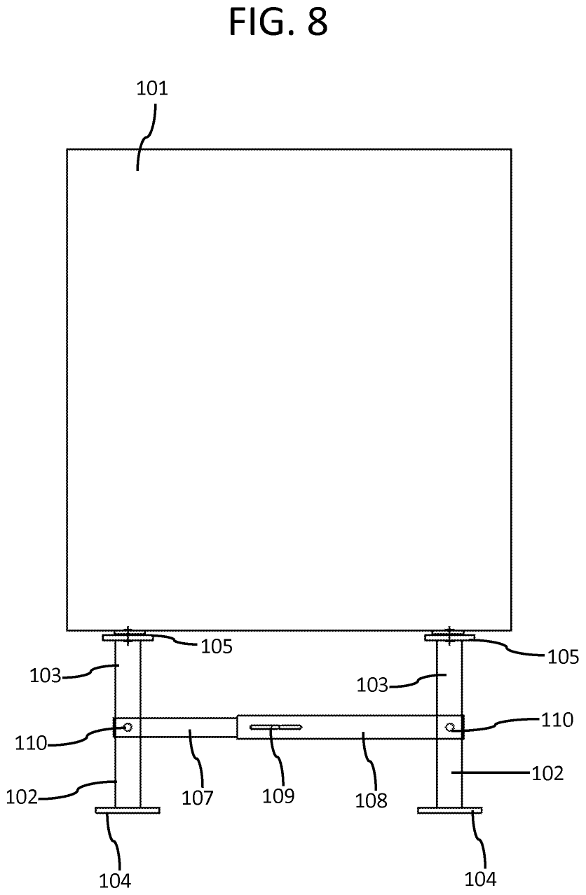

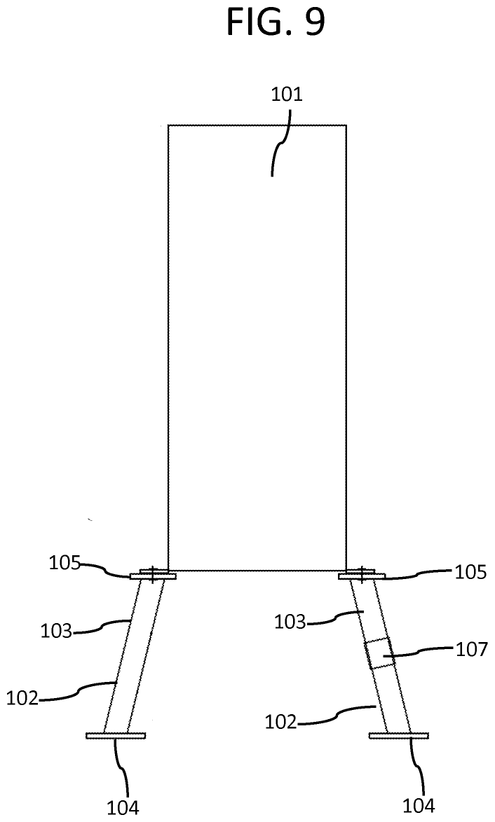

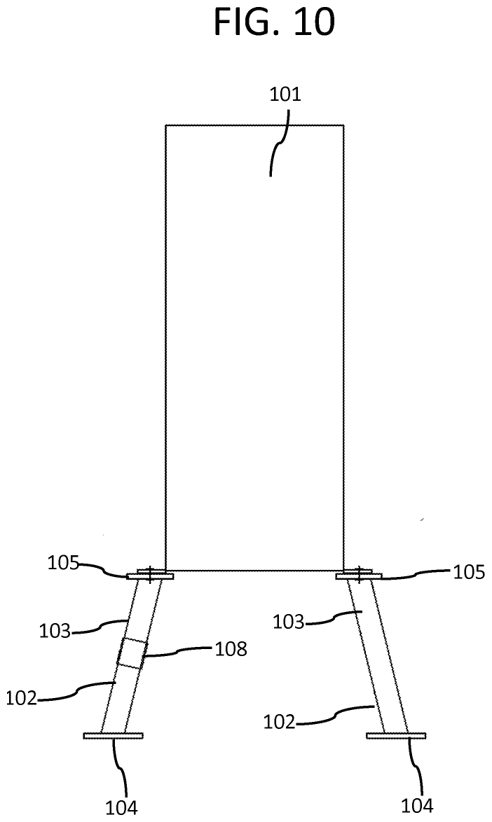

In another embodiment of the subject invention, as shown in FIGS. 7 through 10, the individual legs (102) may each contain pre-drilled openings (110) configured to receive fasteners for attaching a first horizontal crossbar (107) and second horizontal crossbar (108). The first horizontal crossbar (107) and second horizontal crossbar (108) are slidably attached at a slotted mount (109). The slotted mount (109) allows flexible telescopic positioning of the first horizontal crossbar (107) and second horizontal crossbar (108) to match a variety of base configurations while providing additional stability to the system. The slotted design (125) also permits minor telescopic adjustments in unit placement during installation to accommodate on-site conditions or irregular heat pump outdoor geometries.

The components of the leg support system may be known by various alternative names depending on industry standards. The vertical shaft (103) may also be referred to as the support column, upright post, leg stem, vertical support, or riser tube. The footpad (104) may be alternatively described as the base plate, ground contact, stabilizing foot, support pad, or footing plate. Similarly, the mounting plate (105) may be known as the attachment bracket, top flange, mounting bracket, unit interface plate, or heat pump outdoor mounting surface.

Possible types of fasteners include, but are not limited to hex bolts, carriage bolts, machine screws, self-tapping screws, lag bolts, threaded studs, washers, lock washers, nylon insert lock nuts, wing nuts, and anti-vibration bushings or spacers. The mounting plate (105) pre-drilled openings (106) may vary in size, shape, and spacing, including pre-drilled round holes, elongated (slotted) holes for adjustability, threaded inserts, keyhole slots, and grid or matrix patterns. These configurations support different heat pump outdoor brands and models, enabling secure attachment while allowing for positional adjustments during installation.

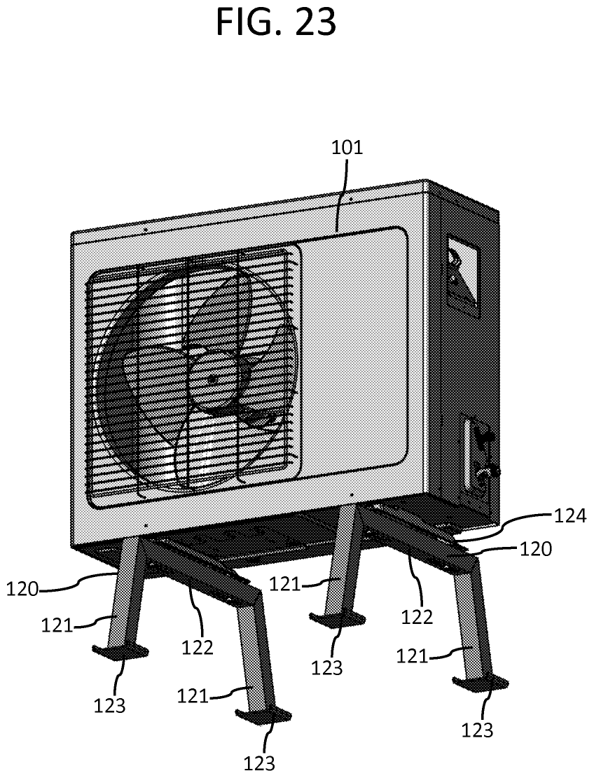

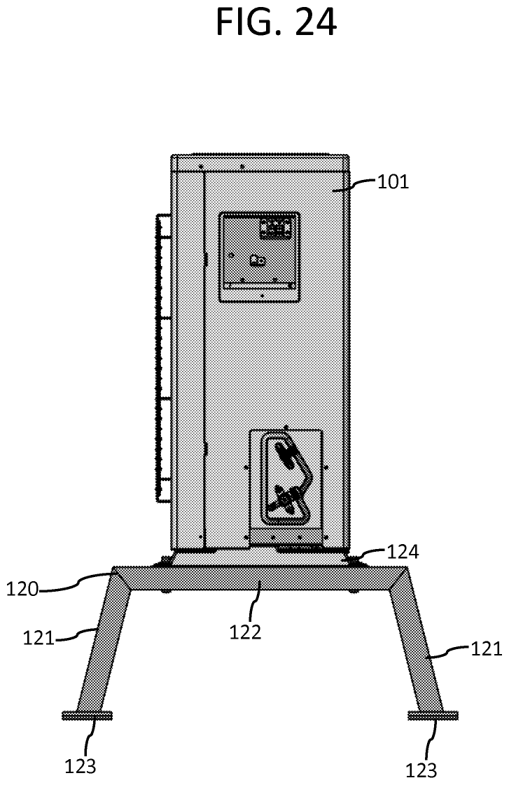

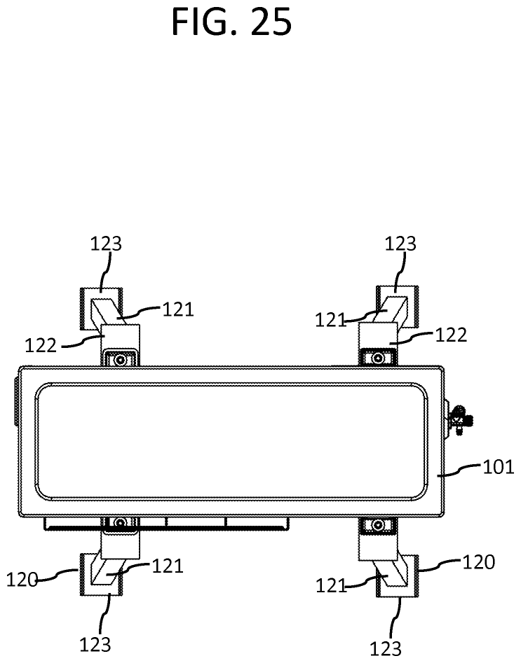

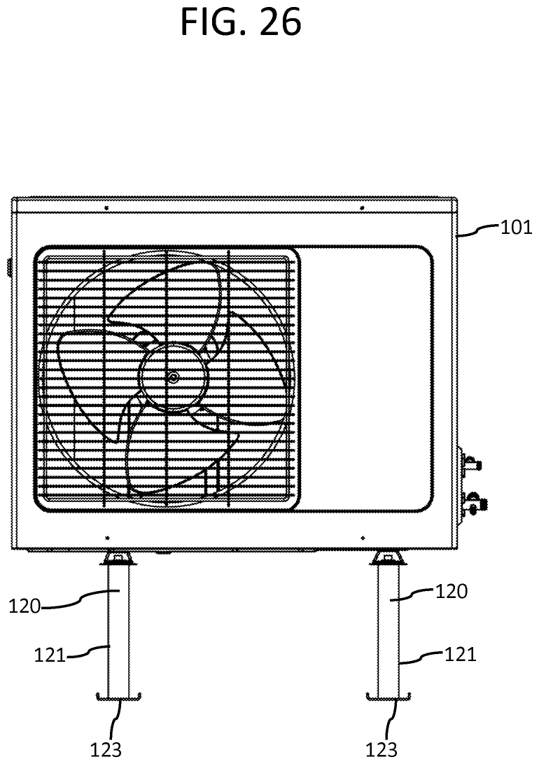

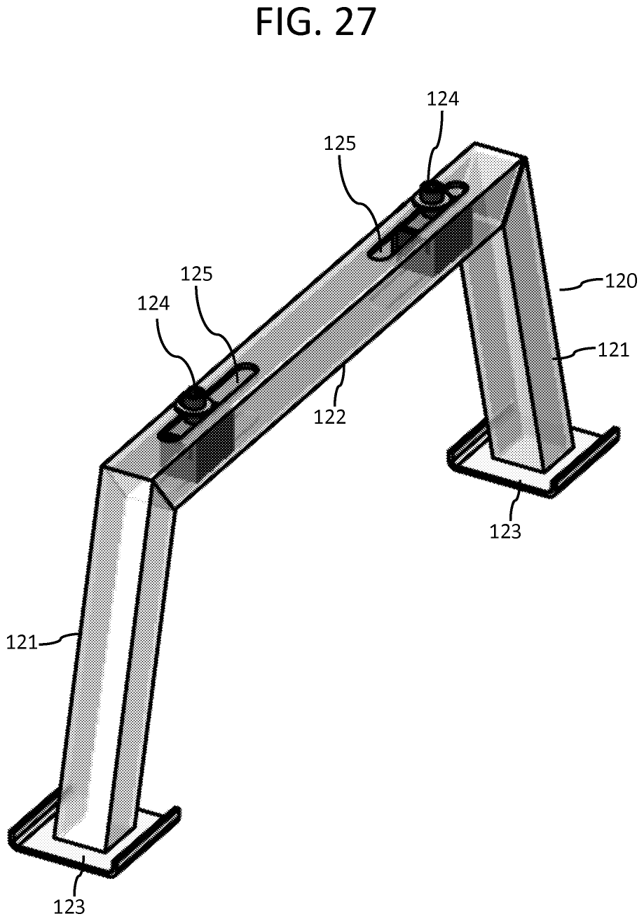

For larger or longer heat pump outdoor units (101), the support system includes double-leg assemblies (120), as illustrated in FIGS. 23 through 27. Each assembly (120) consists of two vertical supports (121) connected near their base by a horizontal crossbar (122), which enhances lateral stability. At the bottom of each vertical support (121), a footpad (123) is included to ensure a secure and balanced ground interface, similar to the individual leg footpad (104).

Mounted across the top of each double-leg assembly (120) is a mounting bracket (124) with an integrated slotted platform (125). This platform (125) provides multiple attachment points for heat pump outdoor units (101), allowing flexible positioning to match a variety of base configurations. The slotted design (125) also permits minor adjustments in unit placement during installation to accommodate on-site conditions or irregular heat pump outdoor geometries. In some embodiments, the crossbar (122) may be telescopic, allowing variable leg spacing for enhanced compatibility.

The present invention provides a modular riser system for elevating and stabilizing a heat pump outdoor unit (101) with four individual heat pump risers (126).

All components described herein—legs (102), assemblies (120), heat pump risers (126), and unit interfaces—are constructed from corrosion-resistant materials to ensure long-term durability and reliable performance in outdoor environments. Common materials include galvanized steel, which offers excellent structural strength and is coated with a layer of zinc to prevent rust and corrosion, and powder-coated aluminum, which provides a lightweight yet durable alternative with a weather-resistant, UV-stable finish that resists chipping, fading, and abrasion. In certain embodiments, stainless steel may be used, particularly in coastal, marine, or industrial settings where salt, chemicals, or pollutants pose an increased risk of corrosion. Stainless steel provides superior resistance to oxidation and chemical exposure, making it ideal for harsh climates. Alternatively, composite polymer materials—including fiberglass-reinforced plastic (FRP), high-density polyethylene (HDPE), and other engineering-grade plastics—may be employed to reduce weight while maintaining strength and weather resistance. These polymer-based materials are non-conductive, rustproof, and often impervious to moisture, making them suitable for installations requiring electrical insulation or minimal maintenance. Additionally, in budget-sensitive or temporary installations, coated carbon steel or recycled materials may be used, provided they meet structural and environmental performance requirements.

Installation of the support system involves aligning the mounting plates (105, 124, or equivalents) with the corresponding base features of the heat pump outdoor unit (101) and securing them using bolts, washers, or other mechanical fasteners. Anti-vibration washers and bushings may be used for further noise and vibration mitigation. Once secured, the legs are positioned on the ground or a prepared surface. For uneven terrain, height-adjustable footpads or shimming materials can be employed to achieve a level, stable base.

This modular support system provides significant advantages over traditional mounting approaches. It elevates the heat pump outdoor unit (101) above ground-level hazards such as water, debris, and pests, enhances airflow, reduces noise transmission, and protects the structural integrity of the heat pump outdoor. The leg system accommodates a wide variety of unit sizes and installation environments, making it a practical, flexible, and durable solution for residential air conditioning systems.

The modular leg support system described herein may be configured in a wide variety of structural arrangements depending on the installation requirements of the heat pump outdoor unit (101). In some embodiments, fewer than four individual legs (102) may be used, while in other embodiments additional legs or support structures may be incorporated to support larger or heavier outdoor units. The legs (102), double-leg assemblies (120), and heat pump risers (126) may be arranged in symmetrical or asymmetrical configurations depending on the footprint, weight distribution, or base geometry of the supported unit.

In certain embodiments, the legs (102), crossbars (107, 108), and assemblies (120) may include adjustable height mechanisms to allow vertical leveling of the heat pump outdoor unit (101). Such mechanisms may include telescoping shafts, threaded height-adjustment collars, adjustable footpads, shims, spacer plates, or other leveling mechanisms commonly used in structural support systems. These features may allow installers to compensate for uneven ground surfaces, sloped terrain, rooftop installations, or irregular mounting conditions.

In some embodiments, the heat pump outdoor unit (101) may be secured to the mounting plates (105), mounting brackets (124), or heat pump risers (126) using adhesives, vibration-dampening compounds, or bonding materials in addition to or in place of mechanical fasteners. In these configurations, the upper surfaces of the legs (102), mounting plates (105), or risers (126) may include textured surfaces, adhesive-receiving surfaces, or vibration-isolating pads to facilitate bonding and improve stability of the supported unit.

The support system described herein may also include integrated vibration isolation elements. These elements may include elastomeric pads, rubber isolators, polymer dampeners, spring mounts, or composite vibration-reduction components positioned between the heat pump outdoor unit (101) and the mounting surfaces. Such vibration mitigation features may reduce transmission of operational vibrations to the ground surface or building structure, thereby improving noise reduction and system longevity.

In additional embodiments, the legs (102), crossbars (107, 108), double-leg assemblies (120), and heat pump risers (126) may include integrated anchoring features to secure the support system to a ground surface, concrete pad, deck structure, rooftop platform, or other mounting foundation. Such anchoring features may include anchor holes, anchor brackets, embedded mounting plates, threaded anchor receivers, or ground spikes designed to prevent movement due to wind loads, seismic activity, or other environmental forces.

Although the system is described primarily in connection with residential heat pump outdoor units (101), the support system may also be used with a variety of outdoor HVAC equipment including, but not limited to, air conditioning condenser units, mini-split outdoor units, variable refrigerant flow (VRF) systems, refrigeration condenser assemblies, heat exchange modules, compressor units, and other outdoor mechanical equipment requiring elevation above a supporting surface.

In certain embodiments, the components of the support system may be manufactured using a variety of fabrication methods including casting, extrusion, machining, stamping, injection molding, compression molding, additive manufacturing, or welded fabrication. The components may also be manufactured as modular assemblies or as integrated monolithic structures depending on manufacturing preferences and load requirements.

In further embodiments, the legs (102), double-leg assemblies (120), and heat pump risers (126) may include protective coatings or surface treatments designed to increase durability and environmental resistance. Such treatments may include powder coating, galvanization, anodization, epoxy coatings, corrosion inhibitors, UV-resistant coatings, or other protective finishes suitable for outdoor use.

In some installations, the support system may be used in combination with pre-existing mounting structures such as concrete pads, mounting rails, rooftop brackets, or equipment platforms. In such configurations, the legs (102) or risers (126) may function as intermediate elevation supports between the equipment base and the underlying mounting structure.

The modular configuration of the system allows installers to select combinations of legs (102), double-leg assemblies (120), crossbars (107, 108), and heat pump risers (126) that best match the dimensions, weight distribution, and installation conditions of the supported equipment. This modularity provides flexibility in installation while maintaining structural stability and compatibility with a wide range of outdoor HVAC equipment.

The structural elements described herein—including the legs (102), crossbars (107, 108), double-leg assemblies (120), heat pump risers (126), mounting plates (105), mounting brackets (124), and associated components—may be implemented in a variety of shapes, dimensions, and structural configurations without departing from the scope of the present invention. These components may include rectangular, circular, square, tubular, cylindrical, hollow, solid, lattice, or reinforced structural profiles, and may incorporate ribs, gussets, reinforcement plates, or other structural features intended to increase load-bearing capacity or stability. The particular geometry illustrated in the drawings is therefore exemplary and not limiting.

In certain embodiments, individual components of the support system may be formed as separate modular parts that are assembled during installation. In other embodiments, some or all of the components may be manufactured as integrated or partially integrated structures. For example, the vertical shaft (103), footpad (104), and mounting plate (105) may be formed as a single integrated unit, or the crossbars (107, 108) and slotted mounts (109) may be integrated directly into the legs (102) or double-leg assemblies (120). Similarly, the heat pump risers (126) may be manufactured as discrete components or may be integrated with other structural supports to form unified support assemblies.

It should also be understood that the relative positioning and orientation of the components described herein may be modified while still achieving the intended function of elevating and stabilizing the heat pump outdoor unit (101). For example, the legs (102), assemblies (120), and risers (126) may be positioned at the corners, edges, midpoints, or other locations beneath the supported unit depending on the design of the equipment base and the desired load distribution. In addition, the crossbars (107, 108), mounting brackets (124), and risers (126) may be oriented in various directions or arranged in alternative configurations to provide structural support, stability, or adjustability while remaining within the spirit and scope of the present invention.

While several variations of the present invention have been illustrated by way of example in particular embodiments, it is apparent that further embodiments could be developed within the spirit and scope of the present invention. However, it is to be expressly understood that such modifications and adaptations are within the spirit and scope of the present invention, and are inclusive, but not limited to the following appended claims as set forth.

1. A modular leg support system for supporting a heat pump outdoor unit of a residential air conditioning system, the system comprising:
a) four individual legs, each individual leg comprising:
i. a vertical shaft configured to provide structural height and load-bearing capacity;
ii. a footpad at a lower end of the vertical shaft, the footpad having a broad, flat surface to provide ground contact and stability; and
iii. a mounting plate at an upper end of the vertical shaft, the mounting plate including a plurality of pre-drilled openings configured to receive fasteners for attaching the leg to a base of the heat pump outdoor unit; wherein the individual legs are configured to elevate and stabilize the heat pump outdoor unit above ground level to enhance airflow, reduce vibration, and protect against environmental hazards.

2. A modular leg support system for supporting a heat pump outdoor unit of a residential air conditioning system, the system comprising:
a) one or more double-leg assemblies, each double-leg assembly comprising:
i. two vertical supports;
ii. a horizontal crossbar connecting the vertical supports near their base;
iii. a footpad at a lower end of each vertical support; and
iv. a mounting bracket extending across the top of the two vertical supports, the mounting bracket including a slotted platform configured to receive fasteners and allow for adjustable positioning of the heat pump outdoor unit; wherein the double-leg assemblies are configured to support larger or longer heat pump outdoor units, and the crossbar may be telescopic to accommodate various unit dimensions.

3. The system of claim 1, wherein the mounting plate further comprises anti-vibration bushings positioned within the pre-drilled openings.

4. The system of claim 1, wherein the vertical shaft includes an angled stabilizing brace extending between the shaft and the mounting plate.

5. The system of claim 1, wherein a vibration dampener is positioned between the vertical shaft and the mounting plate to reduce mechanical vibration.

6. The system of claim 1, wherein the footpad is height-adjustable to allow leveling on uneven terrain.

7. The system of claim 1, wherein the mounting plate includes slotted openings for variable heat pump outdoor mounting configurations.

8. The system of claim 1, wherein the components are constructed from corrosion-resistant material selected from the group consisting of galvanized steel, powder-coated aluminum, stainless steel, and polymer composite.

9. The system of claim 1, wherein the fasteners are selected from the group consisting of hex bolts, carriage bolts, machine screws, lag bolts, washers, lock washers, and nylon insert lock nuts.

10. The system of claim 1, wherein each individual leg is removable and repositionable to accommodate different heat pump outdoor unit footprints.

11. The system of claim 1, wherein the individual legs are used in combination with at least one double-leg assembly.

12. The system of claim 2, wherein the horizontal crossbar is telescopically extendable to adjust spacing between the vertical supports.

13. The system of claim 2, wherein the slotted platform of the mounting bracket includes elongated holes to accommodate variable fastener spacing.

14. The system of claim 2, wherein the footpads of the double-leg assembly are configured to pivot relative to the vertical supports for improved ground conformity.

15. The system of claim 2, wherein the mounting bracket includes vibration dampening elements integrated into the platform.

16. The system of claim 2, wherein the mounting bracket is configured to attach to heat pump outdoor units with rectangular or square footprints.

17. The system of claim 2, wherein the double-leg assemblies are constructed from corrosion-resistant material selected from the group consisting of galvanized steel, powder-coated aluminum, stainless steel, and polymer composite.

18. The system of claim 2, wherein at least one of the footpads is height-adjustable for leveling the heat pump outdoor unit on uneven terrain.

19. The system of claim 2, wherein the slotted platform includes a grid or matrix of openings to support a variety of heat pump outdoor unit mounting geometries.

20. The system of claim 2, wherein the double-leg assembly further comprises an anti-vibration washer system coupled between the mounting bracket and the heat pump outdoor unit.
